(19) United States
(12) Patent Application Publication
(10) Pub. No.: US 2026/0261239 A1
(43) Pub. Date: Sep. 3, 2026

(54) METHODS AND SYSTEMS FOR SOLAR TRACKER OPTIMIZATION VIA AERIAL IMAGE ANALYSIS

(71) Applicant: Nextpower LLC, Fremont, CA (US)

(72) Inventors: Aron Peter Dobos, Denver, CO (US); Amir Asgharzadeh Shishavan, San Rafael, CA (US); Alexander W. AU, Oakland, CA (US); Ricky Barelli Dunbar, Millner (AU); Mustafa Tekin Dokucu, Latham, NY (US); Andrew J. Weber, Portland, OR (US)

(21) Appl. No.: 19/552,058

(22) Filed: Feb. 27, 2026

Related U.S. Application Data
(60) Provisional application No. 63/765,307, filed on Feb. 28, 2025.
(60) Provisional application No. 63/765,317, filed on Feb. 28, 2025.

(51) Int. Cl. H02S 50/15; G06V 20/10; H02S 20/32

(52) U.S. Cl. CPC H02S 50/15; G06V 20/176; H02S 20/32

(57) ABSTRACT

Methods of operating a solar power plant system, including providing initial three-dimensional mapping information for the solar tracker rows, measuring an observed amount of shading of solar tracker rows, using information to determine an expected amount of shading of solar tracker rows, comparing the observed shading to the expected shading, and calculating corrected values of the three-dimensional mapping information for the solar tracker rows. Additional methods include observing shading and light patterns relative to a solar array having a plurality of solar tracker rows to enable corrections to be made to input data regarding positions of solar tracker rows in three-dimensional space, the observations and measurements optionally being facilitated by the use of unmanned aircraft (e.g., drones) during the operation of certain solar tracking algorithms by the solar power plant system.

### CROSS-REFERENCE TO RELATED APPLICATIONS

This application claims priority to U.S. Provisional Patent Application No. 63/765,307, filed Feb. 28, 2025, and to U.S. Provisional Patent Application No. 63/765,317, also filed Feb. 28, 2025, the contents of both of which are incorporated herein by reference in their respective entireties.

### TECHNICAL FIELD

This disclosure relates generally to solar tracker systems, and more particularly to systems and methods for improving backtracking methods employed by solar tracking systems using aerial images and analysis.

### BACKGROUND

Solar panels are generally composed of an array of solar cells, which are interconnected to each other. The cells are often arranged in series and/or parallel groups of cells in series. Solar panels typically generate more energy in sunny conditions when oriented towards the sun at a certain angle (e.g., angled to present a solar panel surface area that is normal or perpendicular to the direction of incident rays of sunlight, a “normal incidence angle”). Many solar panel systems are designed in combination with solar trackers, which enable the solar panels or solar modules to follow the sun's trajectory across the sky from east to west throughout a typical day in an attempt to maximize the electrical generation of the solar panel systems.

Typically, a relatively large number of solar cells or modules are arranged in an array to generate energy in sufficient amounts to be usable, for example as part of an energy grid. As a result, solar trackers have been developed that are quite large, spanning hundreds of feet in length and including hundreds of individual solar modules that are mechanically coupled to support structures. An array of solar trackers may be formed of a plurality of solar tracker rows that are oriented generally parallel to each other, often in a north-to-south configuration, which may facilitate rotating or tilting the solar modules throughout the day to attempt to follow the trajectory of the sun and maximize the energy produced.

In some cases, shading may occur on the solar modules of a given solar tracker row, such as shade caused by an adjacent solar tracker row. This may occur as a result of relatively tight spacing of adjacent solar tracker rows to improve the energy production of a given area, for example. Certain techniques and/or algorithms have been employed which may result in moving/rotating one solar tracker row to an angle other than a normal incidence angle in order to avoid shading. It may be the case, for example, that a reduction in output from moving a solar tracker row to a less-than-optimal angle relative to the sun may be more than offset by a corresponding gain in solar energy production that may be caused by avoiding shading of a solar tracker row. There may also be situations where it may be advantageous to allow some sunlight to reach the ground between adjacent solar tracker rows (e.g., allowing some amount of uncaptured energy), if doing so may avoid shading, for example.

Accordingly, a need continues to exist for improved methods and techniques for maximizing the efficiency of solar arrays.

### SUMMARY

Embodiments of this disclosure provide tracking systems that may be suitable for controlling solar modules or panels or solar tracker rows. In general, the present disclosure relates generally to solar tracker systems, and more particularly to systems and methods of controlling the orientation of solar tracker rows and associated solar modules of a solar array to improve the overall energy production of a solar array. In one example, a solar tracking system may include a plurality of solar tracker rows arranged generally in parallel to each other in a north-south direction, wherein each solar tracker row may include a plurality of support piers, a torque tube extending along the solar tracker row and rotatably supported on the plurality of support piers, and a plurality of solar module assemblies coupled to the torque tube associated with each solar tracker row.

Disclosed herein is a method of operating a solar power plant system. The method includes providing a solar array formed of a plurality of solar tracker rows arranged in a generally longitudinal orientation, the solar tracker rows being spaced apart from each other in a direction generally transverse to the longitudinal orientation, the solar tracker rows having solar modules coupled thereto, the solar tracker rows being configured to rotate to a solar tracker angle relative to a position of the Sun in the sky. The method may include providing an initial three-dimensional mapping of the solar tracker rows across the solar array. In some embodiments, the method includes receiving or measuring an observed amount of shading on a first solar tracker row due to a second solar tracker row at a time “T,” where the second solar tracker row is adjacent to the first solar tracker row (e.g., the second row is the next solar tracker row immediately adjacent the first solar tracker row on one side of the first solar tracker row). The method may include receiving information regarding: the position of the Sun at the given time T; the solar tracker angle of the first solar tracker row at the time T; the solar tracker angle of the second solar tracker row at the time T; and the initial three-dimensional mapping of the first solar tracker row and the second solar tracker row (e.g., the X, Y, and Z coordinates, possibly at multiple points disposed along each of the respective solar tracker rows). The method may include determining an amount of expected shading on the first solar tracker row due to the second solar tracker row at time T, comparing the observed amount of shading to the expected amount of shading, and calculating corrected or updated X, Y, and/or Z coordinate values (e.g., elevation values) for points along either the first or second solar tracker rows that would produce the observed amount of shading, updating the three-dimensional mapping of one or both of the first and second solar tracker rows with the corrected/updated X, Y, and/or Z coordinate values, and operating the solar array to produce power. In some embodiments, the method may include similar steps relating to light that reaches the ground (uncaptured light) between adjacent solar tracker rows. That is, an observed amount of uncaptured light on the ground is measured between a first solar tracker row and a second solar tracker row, and based on similar received information, an expected amount of light on the ground between the first and second solar tracker rows is determined (or estimated), a comparison is made between the observed amount of light on the ground and the expected amount of light on the ground, and updated Z coordinates may be calculated and used to update the three-dimensional mapping of the solar tracker rows of the solar array.

Disclosed herein is a method of operating a solar power plant system that includes obtaining aerial image data of a solar array during a backtracking period, processing the aerial image data to detect each of the plurality of solar tracker rows, mapping each solar tracker row to a unique identification number (“unique ID”), processing the aerial image data to measure an observed amount of shading on a first solar tracker row due to a second solar tracker row at a time T during the backtracking period, and providing a shade level geometry measurement for each solar tracker row. In some embodiments, a method of operating a solar power plant system further includes processing the aerial image data to measure an observed amount of light on a ground surface between the first solar tracker row and the second solar tracker row at a time T during the backtracking period, and providing a light level geometry measurement for each solar tracker row identification number at the time T. The light level geometry measurement may include a size and shape of the light on the ground associated with an area between a given pair of solar tracker rows (or between a pair of unique IDs corresponding to a pair of adjacent solar tracker rows.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is a schematic, perspective view of an exemplary solar tracker that may be used in conjunction with some embodiments of this disclosure;

FIG. 2 is a schematic, top view of a solar tracking system including a plurality of solar tracker rows, according to some embodiments of this disclosure;

FIGS. 3A and 3B are schematic side/end views of several solar tracker rows of a solar array arranged on exemplary rolling terrain according to some embodiments of this disclosure;

FIG. 4A is a schematic, perspective view of an exemplary solar array having a plurality of solar tracker rows according to some embodiments of this disclosure;

FIGS. 4B and 4C are enlarged, schematic, perspective views of portions of the solar array of FIG. 4A, showing examples of shading and light scenarios according to some embodiments of this disclosure;

FIGS. 5A and 5B are schematic views of shading scenarios according to some embodiments of this disclosure;

FIGS. 6A and 6B are schematic views of light scenarios according to some embodiments of this disclosure;

FIG. 7A is a table illustrating exemplary position/location/topographical information corresponding to the solar tracker rows of a solar array according to some embodiments of this disclosure;

FIG. 7B is a listing of exemplary parameters that may be used in a solar tracking algorithm for defining and/or describing a plurality of solar tracker rows of a solar array according to some embodiments of this disclosure;

FIG. 8 is a flow chart showing exemplary steps of a method for operating a solar power plant system according to some embodiments of this disclosure;

FIG. 9 is a flow chart showing exemplary steps of a method for operating a solar power plant system according to some embodiments of this disclosure; and

FIG. 10 is a flow chart showing exemplary steps of a method for operating a solar power plant system according to some embodiments of this disclosure.

### DETAILED DESCRIPTION

The present disclosure is directed to solar tracking systems and methods for improving backtracking algorithms employed by solar tracker systems to improve overall output. Photovoltaic (PV) power systems are used to generate electrical power from solar energy and may include tracking systems to increase the amount of electrical power generated. Solar tracking systems with PV modules mounted or operatively coupled to them may be referred to as “solar trackers.” The tracking systems may enable solar modules to be rotated to track the sun as the sun moves across the sky.

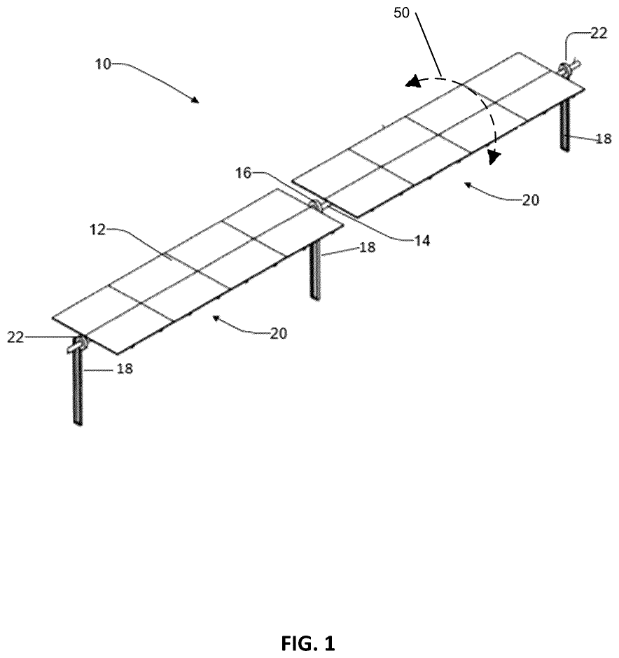

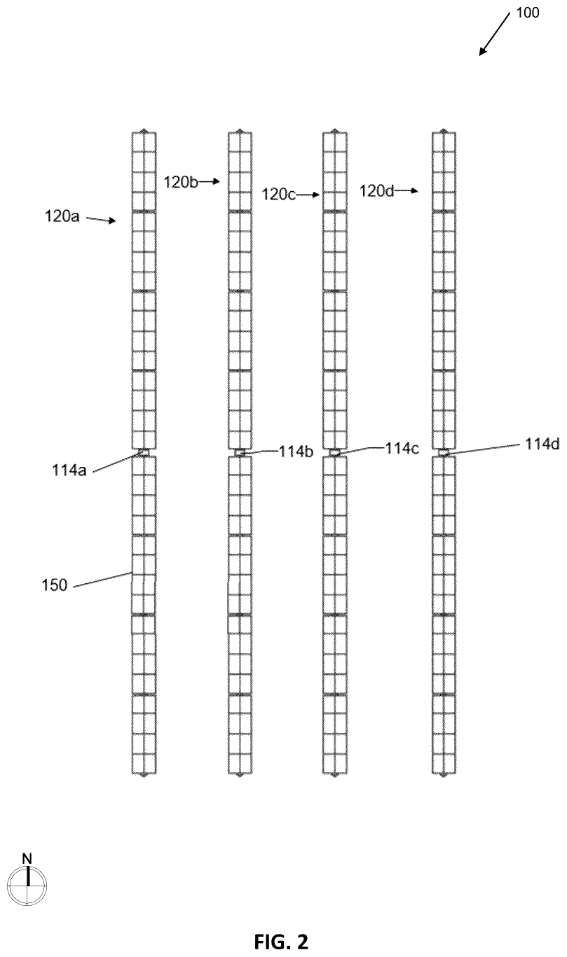

Referring now to the drawings, FIG. 1 illustrates a perspective view of a common arrangement of a solar tracker 10 provided in accordance with the present disclosure. The solar tracker 10 has bays 20 defined by the distance between ground piers 18 (generally referenced herein as piers 18). The solar tracker 10 may be a part of a larger solar tracker system that may include a plurality of solar trackers 10 arranged in rows, an example of which is shown in FIG. 2, where each row of solar trackers 10 may be referred to as a solar tracker row. FIG. 1 illustrates two bays 20 of the solar tracker row 10. However, it will be appreciated that the solar tracker row 10 may include four bays, six bays, ten bays, twenty bays, or any other suitable number of bays as desired or as appropriate. At each pier 18 is either a bearing 22, or as shown in FIG. 1, a drive mechanism 16, shown for example near the center of the solar tracker row 10. Each of the bearings 22 and the drive mechanism 16 are supported by one of the piers 18. Activation of the drive mechanism 16 rotates a torque tube 14 about an axis of rotation and thus rotates one or more solar modules 12 mounted to the torque tube 14 such that the solar modules 12 can be oriented to a desired position (e.g., to a desired angle relative to the position of the sun in the sky as it moves during the day). In some situations, the desired position of a solar module 12 may be a position to capture maximum sunlight based on the location of the sun in the sky (e.g., positioned generally perpendicular to the incident rays coming from the sun). In other cases, the desired position of a solar module 12 may be at a 0-degree angle position (e.g., horizontal) during times of diffuse light (e.g., on cloudy days). In still other circumstances, the desired position of a solar module 12 may be a safety position intended to protect the solar modules 12 from certain weather conditions, such as high winds or during a storm. In many situations, the desired position of a solar module 12 (e.g., the desired angular orientation) may be any position desired by the operators of the solar power plant, which may be based, for example, on the location of the associated solar tracker row 10, and/or on the current weather and atmospheric conditions, the current demands of the grid, and other factors (e.g., including positions in between any of the above-described positions). The bearings 22 may function to reduce to the extent possible the resistance to movement of the torque tube 14 and the solar modules 12 during any desired positioning of the solar tracker rows 10, for example.

The torque tube 14 is sized (e.g., diameter, wall thickness, material) such that sag or sagging of portions of the torque tube 14 between the piers 18 is reduced or substantially eliminated and to absorb torsional loads applied to the torque tube 14 by wind loading and/or other forces. In addition, since there may be just a single drive mechanism 16 (e.g., a single drive mechanism 16 for an entire solar tracker row 10, for example), the specifications for the torque tube 14 may also seek to minimize or eliminate twist of the torque tube 14 along its length. Any such twisting of a torque tube 14 would likely result in at least some of the solar modules 12 being oriented differently from what is desired, which can reduce the output and efficiency of the solar tracker 10, particularly as a solar tracker row 10 is rotated to the extreme angles of its permitted operating range (e.g., up to +/−75 degrees from horizontal or more), for example, during stowing operations, as indicated generally by arrow 50 in FIG. 1.

As shown in FIG. 1, a number of solar modules 12 may be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis (or about an axis that is offset somewhat from the longitudinal axis of the torque tube 14 in some embodiments) to adjust an angular orientation of the solar modules 12 relative to the sun, while supporting the solar modules 12 on the bracket system. The bracket system may take many forms including pieces of shaped steel, which may be arranged to sandwich the solar modules 12, and may be configured to connect to a rail, which is then coupled to the torque tube 14, for example.

FIG. 2 is a top view of a solar tracker system 100 comprising a plurality of solar tracker rows 120, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged substantially parallel to each other in a generally north-south orientation, as indicated in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other adjacent solar tracker rows 120, and exterior solar tracker rows are solar tracker rows 120 having one solar tracker row 120 disposed on one side, and no solar tracker row(s) 120 disposed on the other side. The solar tracker rows 120 may be composed of a plurality of solar modules or solar module assemblies 150 arranged in a north-south longitudinal orientation to form the solar tracker rows 120. The solar module assemblies 150 may include a plurality of solar modules, such as the solar modules 12 shown in FIG. 1. Each one of the plurality of solar module assemblies 150 may be supported on a torque tube 114a, 114b, 114c, 114d (collectively referred to herein as torque tubes 114). The torque tubes 114 in turn are supported by a plurality of support piers (not explicitly shown in FIG. 2). The torque tube 114 may be an example of the torque tube 14 shown in FIG. 1. As shown in FIG. 2, the solar tracker rows 120 may be separated by a space sufficient to allow machinery to travel therethrough to allow for cleaning and maintenance.

U.S. Pat. No. 11,300,326, which is incorporated herein by reference in relevant part, describes a technique that may improve the efficiency of solar energy production of a solar array. For example, such techniques (which are sometimes referred to as “backtracking” algorithms or methods) may improve efficiency by having some solar tracker rows oriented in an “on sun” position normal to incident rays from the sun, while having some other solar tracker rows oriented in an “off sun” position that helps avoid shading (e.g., blocking incident rays from the sun) of a given solar tracker row from other solar tracker rows, or helps avoid having a given solar tracker row cause shading of other solar tracker rows.

In an example described in U.S. Pat. No. 11,300,326, a solar tracker system may have a first tracker apparatus comprising a first row of a plurality of solar modules, wherein the solar modules of the first solar tracker row are configured to face in a normal manner in an on sun position in an incident direction of electromagnetic radiation derived from the sun. The system may further include a second tracker apparatus comprising a second row of a plurality of solar modules, wherein the solar modules of the second solar tracker row are configured to face in an off sun direction such that the solar modules of the second solar tracker row do not block and shade the solar modules of the first solar tracker row.

In another example described in U.S. Pat. No. 11,300,326, a measuring device disposed on each row will identify when a row starts to become shaded and it will be recorded by the system. The system may use row-to-row information to optimize one or more tracking angles based on local conditions, such as, for example, sloping hills and changing ground cover ratios or other non-uniformities. In some examples, the system may attempt to optimize for shading that may only be from the East or the West (e.g., shading that occurs in the mornings and/or evenings due to the sun's position nearer the horizon during those periods), although there can be other variations.

In another example described in U.S. Pat. No. 11,300,326, the tracker system may have at least a first tracker apparatus comprising a first row of a plurality of solar modules. In an example, each of the solar modules is spatially configured to face in a normal manner in an on sun position in an incident direction of electromagnetic radiation derived from the sun. The system has a second tracker apparatus having a second row of a plurality of solar modules. In an example, each of the solar modules is configured in an off sun direction such that each of the solar modules does not block and shade any one of the plurality of solar modules from the first row using feedback from a measuring device coupled to second tracker device.

In another example described in U.S. Pat. No. 11,300,326, the system may have a backtracking module configured to determine a shading avoidance position. Such a system may use captured information to determine a desired energy output at a first angle position, and may use a second angle position to avoid shading if the energy output at the second angle position is greater than the desired energy output at the first angle position, and further configured to use the first angle position if the energy output at the second angle position is less than the desired energy output at the first angle position.

In another example described in U.S. Pat. No. 11,300,326, the system may also have a pier height topography module configured to gather shading information as each of the solar tracker rows traverse from an initial position to a final position and from the final position to the initial position to determine a pier height for each tracker apparatus and a row sequencing for each tracker apparatus. In a particular example, a pier height may be determined using the following technique, which can be updated, modified, or combined:
Set and hold all rows to a predetermined angle (e.g., 60 degrees toward east) in the morning until a certain predetermined time (e.g., 10:00 a.m.);
Resume/continue normal tracking;
Set and hold all rows to a predetermined angle (e.g., 60 degrees toward west) in the afternoon starting at a certain predetermined time (e.g., 3:00 p.m.);

Data Acquisition:

A voltage drop corresponding to a given solar tracker row would be detected as a shading event.

Each instance of a solar tracker row shading event is reported back to a main controller.

Data Analysis:

Based on analysis of the shading event time, site location, panel type, etc., algorithms are applied to estimate the row height difference of each solar tracker row, as well as the row sequencing (from east to west).

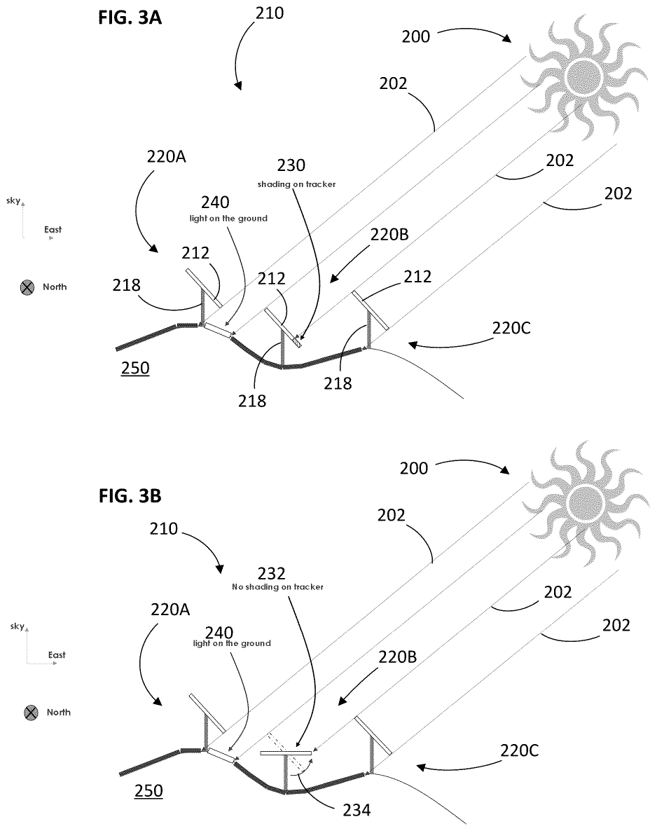

FIG. 3A is a schematic side view of a portion of a solar array 210 showing several solar tracker rows 220A, 220B, and 220C as they might be arranged on rolling terrain 250 as shown. The solar tracker rows 220A, 220B, and 220C are disposed generally parallel to each other, and in a generally North-South orientation. As depicted in FIG. 3A (looking North from the South), only a single pier 218 and an end portion of a single solar module 212 can be seen corresponding to each of the solar tracker rows 220A, 220B, and 220C, although a plurality of piers 218 and/or solar modules 212 would typically be expected as part of each row. Also depicted is the Sun 200 as it might appear in the morning (e.g., to the East of the solar array 210 as shown), having rays of sunlight 202 as they might be directed towards the solar modules 212 of the solar tracker rows 220A, 220B, and 220C. As shown in FIG. 3A, the solar trackers for solar tracker rows 220A, 220B, and 220C have oriented or positioned these rows at an angle to face in a normal (e.g., generally perpendicular) direction to the incident rays of sunlight 202 at this moment in time. As the Sun 200 continues to traverse the sky throughout the day moving east to west, the solar tracker rows 220A, 220B, and 220C might typically be moved to maintain a generally normal or “optimal” orientation relative to the position of the Sun 200 in the sky in order to maximize the amount of energy produced by the solar array 210.

Also shown in FIG. 3A are two conditions that may cause or result in reduced performance or efficiency of the solar array 210. For example, solar tracker row 220B is shown being partially shaded by solar tracker row 220C, as indicated at shade 230, in the particular situation depicted. Also shown is an area of light on the ground 240 between solar tracker row 220A and solar tracker row 220B, representing uncaptured light. In the case of shade 230, reduced performance (e.g., reduced energy produced) from the affected solar modules may be quite significant compared, for example, to a scenario in which the solar modules on row 220B were uniformly illuminated. In the case of light on the ground 240, this indicates that a certain amount of solar energy falling within the area of the solar array 210 is not being captured and is essentially wasted.

FIG. 3B is a schematic view of a portion of the solar array 210 of FIG. 3A, showing a change in orientation of one of the solar tracker rows in an attempt to address one of the two conditions noted above. In particular, solar tracker row 220B has been rotated (moved) to an angle 234 at which there is no shading (indicated at 232) on the solar modules of the affected solar tracker row 220B. Depending on various factors (for example, the amount of shading), the energy production from the affected row (e.g., solar tracker row 220B in this example) may improve after moving to new angle 234, or it may not, in which case, it may have been preferable to maintain the original position. Modifying the angles of one or more solar tracker rows in an array in this manner (e.g., in an attempt to improve the overall energy production) is sometimes referred to as “backtracking.” It is also noted that the backtracking of row 220B employed in FIG. 3B did not improve the light on ground condition 240 in FIG. 3A; there is still uncaptured light on ground 240, and backtracking of row 220B may have possibly made the area of light on ground 240 somewhat larger than it had been previously (before backtracking was initiated).

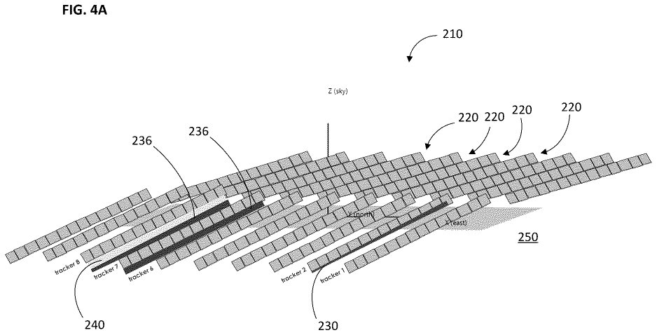

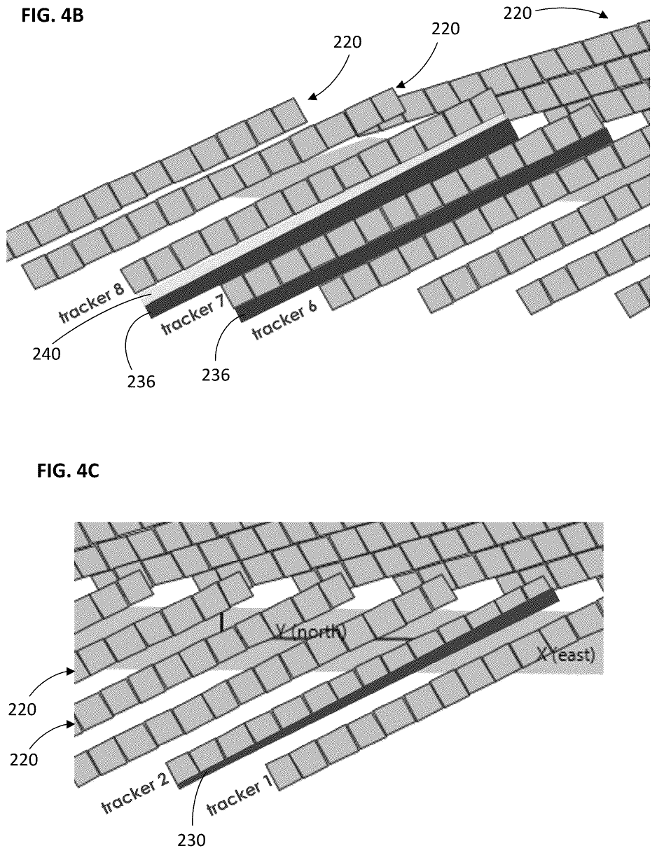

In the examples described with respect to FIGS. 3A and 3B, it was assumed for simplicity that the amount of shade 230 on a solar tracker row, or the amount of uncaptured light on the ground 240 between adjacent solar tracker rows, was uniform along the length of the affected solar tracker rows. However, other factors can affect how the shade 230 or light 240 may present itself along the length of a given solar tracker row, including changes in the overall shape of the shade 230 or light 240 along a length of a row. FIGS. 4A-4C illustrate a number of exemplary shading and lighting conditions 230, 240 that may present themselves in a solar array 210. In some embodiments of this disclosure, the shade 230 and/or the light 240 may be observable and possibly quantifiable through the use of aerial imagery (e.g., images obtained via unmanned aircraft or drones, or via satellite imagery, or via other means). In other embodiments of this disclosure, the shade 230 and/or the light 240 may be observed and/or quantified through the use of manual field inspections, or via analysis of electrical data from the solar array 210, for example.

FIG. 4A shows an exemplary perspective view of a solar array 210 having a plurality of solar tracker rows 220 arranged in generally parallel rows oriented in a generally North-South direction and spaced apart from each other in a generally East-West direction as shown. FIG. 4A shows an example in which solar trackers are installed on gently rolling terrain 250. The resulting patterns of shading and uncaptured light are dependent on geometrical considerations and may change over time. In the lower portion of the array 210 (as depicted in FIG. 4A), there are 10 solar tracker rows 220, several of which are labeled (e.g., “tracker 1,” “tracker 2,” etc.) to help describe a number of shading and/or lighting conditions 230, 240 according to various embodiments of this disclosure. For example, between the solar tracker rows labeled “tracker 7” and “tracker 8,” there is an area of shade on the ground 236 and an area of light on the ground 240. Likewise, between the solar tracker rows labeled “tracker 6” and “tracker 7,” there is an area of shade on the ground 236 (but no area of light on the ground 240). An on the solar tracker row labeled “tracker 2,” there is an area of shade on the tracker 230 caused by blocking of the sun's rays (not illustrated) by an adjacent solar tracker row, labeled “tracker 1.”

FIG. 4B is an enlarged portion of FIG. 4A showing additional details. For example, it may be determined that the solar tracker row 220 corresponding to “tracker 7” may not be oriented at the best angle for system energy production, since light on the ground 240 appears between tracker 7 and tracker 8, as shown. On the other hand, the solar tracker row 220 corresponding to “tracker 6,” however, appears to be oriented to a good angle for generating as much solar energy as possible since there is no shading on the solar modules of “tracker 7” (e.g., tracker 6 is not blocking any of the sun's rays from reaching tracker 7), and there is also no uncaptured light on the ground 240 between tracker 6 and tracker 7.

FIG. 4C shows a different enlarged portion of the solar array 210 of FIG. 4A with details regarding the solar tracker rows 220 corresponding to “tracker 1” and “tracker 2.” For example, it may be determined that “tracker 1” (and possibly “tracker 2” as well as “tracker 1”) is not oriented at the best angle for overall energy production, since tracker 1 is creating shade 230 on a portion of “tracker 2,” as shown. It is also noted that the amount of shade or shading 230 on tracker 2 varies along the length of tracker 2; at the left-most end (as depicted in FIG. 4C) of tracker 2, a relatively small amount shade 230 exists (e.g., the left-most solar panel or module appears to be less than 25% shaded), while at the right-most end (as depicted in FIG. 4C) of tracker 2, a relatively large amount shade 230 exists (e.g., the right-most solar panel or module appears to be 50% shaded or more). In some embodiments, it may be desirable to determine or measure an amount of shading for an entire row. In such embodiments, one might calculate an overall surface area of the shade 230, or alternatively, calculate a percentage of the total surface area of the solar modules of a given solar tracker row 220 that is shaded 230. Other numerical scales or scores could be devised to assess or measure the degree to which a solar tracker row is shaded. For example, a scale of 1 to 4, or 0 to 10, etc. could be used to provide this assessment or measurement. Such a measurement, for example, may be useful as a possible trigger for causing some other action to be taken, according to some embodiments of this disclosure.

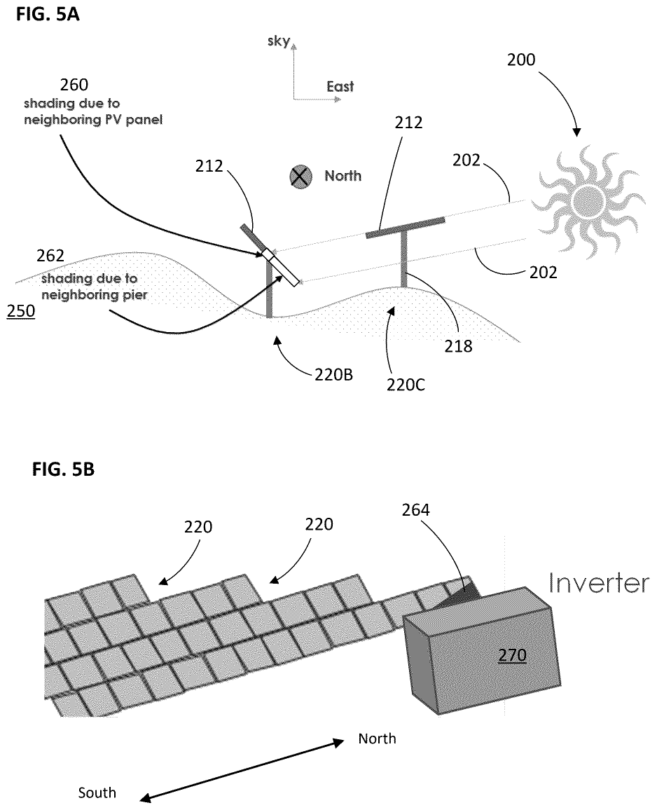

FIGS. 5A-5B illustrate a number of exemplary shading scenarios that may be ignored according to some embodiments of this disclosure. For example, it may be the case that the particular shading effects illustrated in FIGS. 5A and 5B may have a very small or negligible impact on the overall energy production that it may not be worth the effort to attempt to offset such effects (or it may be counterproductive to attempt to do so). It may also (or alternatively) be the case that the shading effects illustrated in FIGS. 5A and 5B may not be remedied in a practical manner.

With reference to FIG. 5A, two shading effects 260 and 262 are illustrated. Shading 260 is an example of shading of solar tracker row 220B caused by solar tracker row 220C. However, in such a scenario, the amount of shading 260 has already been minimized by orienting the solar modules of solar tracker row 220C to an angle that creates the smallest amount of shading on row 220B possible. The solar modules 212 of row 220C are shown substantially parallel to the sun's rays 202 in FIG. 5A, for example. Shading 262 represents shading caused by the pier(s) 218 of solar tracker row 220C. In this case, the amount of shading 262 is relatively small owing to the spacing of piers 218 along the length of a typical solar tracker row. It also may not be practical to reduce the shading 262 caused by neighboring piers 218 in some embodiments.

FIG. 5B illustrates an example of shading 264, which may be caused by other structures, such as other components of the solar array system. For example, an inverter 270 is shown in FIG. 5B casting a shadow on a portion of a solar tracker row 220, as shown. For a variety of reasons, it may not be practical and/or desirable to attempt to remedy or address the existence of shading 264 caused by other structures.

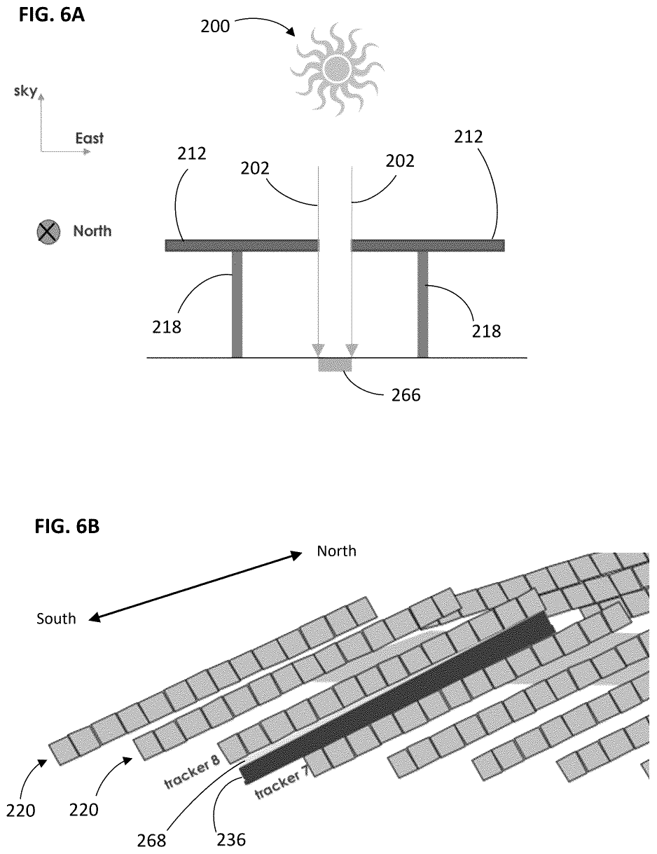

FIGS. 6A-6B illustrate a number of exemplary light-on-ground scenarios that may be ignored according to some embodiments of this disclosure. For example, it may be the case that the particular light-on-ground effects illustrated in FIGS. 6A and 6B may have a very small or negligible impact on the overall energy production that it may not be worth the effort to attempt to offset such effects (or it may be counterproductive to attempt to do so). It may also (or alternatively) be the case that the light-on-ground effects illustrated in FIGS. 6A and 6B may not be capable of being remedied in a practical manner.

FIG. 6A illustrates an exemplary light-on-ground scenario 266 that may arise and that can likely be ignored. In the particular example of FIG. 6A, the Sun 200 is directly overhead, and the sun's rays 202 have a straight path to an area of light on the ground 266 between two adjacent solar tracker rows. Such a scenario does not readily avail itself to a remedy; changing the orientation of the solar modules of one or both solar tracker rows would likely enlarge the size of the light-on-ground pattern 266 (e.g., since the solar modules of both rows are already at a horizontal orientation).

FIG. 6B illustrates an exemplary light-on-ground scenario 268 that may arise and that can likely be ignored. In the particular example of FIG. 6B, an area of light on the ground 268 appears between two adjacent solar tracker rows 220 labeled “tracker 7” and “tracker 8” in FIG. 6B. An area of shade on the ground 236 is also shown disposed between the same two adjacent solar tracker rows 220 labeled “tracker 7” and “tracker 8.” Due to various factors (such as changes in topography, or in the heights of piers along the solar tracker rows, etc.), the light-on-ground pattern 268 tapers down in size to a point such that there is no uncaptured light reaching the ground at the far end (e.g., the right-most end in FIG. 6B) of tracker 7 and tracker 8. At the same time, the shade-on-ground pattern 236 increases in width along the length of tracker 7 and tracker 8 until it is nearly causing shading of the solar modules of tracker 8 (e.g., at the right-most end of tracker 8 in FIG. 6B). In this scenario, any attempt to move tracker 7 to further reduce the amount of light-on-ground 268 would likely result in causing shading on tracker 8. That is, reducing the light-on-ground 268 beyond this point will result in the shade from the shade-on-ground pattern 236 to begin to cause shading on tracker 8. In most cases, the reduction in overall power generation that would result from such shading on tracker 8 (e.g., going from a condition with no shading) would more than offset any incremental gain (e.g., incremental increase in power generation) achieved by reducing the effects of light reaching the ground, and there would accordingly be no reason to take such action.

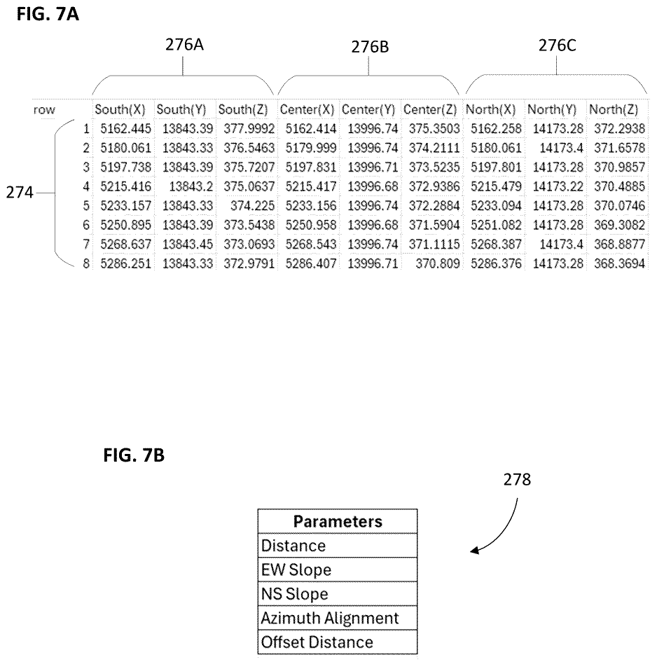

FIG. 7A shows a portion of a table that includes exemplary mapping data (or location data, or topographical data, for example) for a number of rows 274 of a solar array in accordance with embodiments of this disclosure. For example, FIG. 7A shows data corresponding to eight solar tracker rows 274 that make up a portion of a solar array. In the particular example illustrated, the solar tracker rows 274 may be oriented in a generally North-South configuration, as is commonly employed. It should also be noted that each solar tracker row 274 may have a number that easily identifies the row to a user, such as the numbering of rows 274 in FIG. 7A from “row 1” through “row 8,” for example. Each solar tracker row 274 may also have a unique identification number, or unique ID, associated with it for the purposes of communicating with controllers and/or software, for example. A unique identification number may be a serial number or some other series of alphanumeric characters that enable a control system to uniquely identify each solar tracker row 274. In some cases, it may be more convenient to use the row numbering scheme, while in other cases, it may be more convenient to use unique IDs, and in still other cases, it may be desirable to use both numbering schemes.

For each solar tracker row 274 in the example of FIG. 7A, three-dimensional position or location information is provided for three points disposed along each solar tracker row 274—a North point 276A, a South point 276B, and a Center point 276C, as shown in the example provided in FIG. 7A. Of course, more or fewer than three points could be used to provide a “mapping” of each solar tracker row 274 according to various embodiments of this disclosure. Continuing with the example depicted in FIG. 7A, for each of the three points disposed along each solar tracker row 274 (276A, 276B, and 276C), corresponding location information is provided. The location information may comprise three coordinates, such as an X, Y, and Z coordinate, to provide a three-dimensional mapping of the layout of each solar tracker row 274 that makes up the solar array. The X, Y, and Z coordinates may correspond to cartesian coordinates, e.g., grid coordinates, such as longitude, latitude, and altitude (or elevation). The X, Y, and Z coordinates may be provided in various units of distance, such as feet, meters, etc., and they may be provided with respect to a reference point (e.g., relative to a known, fixed point within the array), or they may be provided in some sort of “absolute” terms (e.g., relative to the center of the earth, for example). Thus, in the example provided in FIG. 7A, each solar tracker row may be defined by a series of three points 276A, 276B, and 276C disposed along a length of each row 274, each point defined by three coordinates (e.g., longitude, latitude, and altitude/elevation), for a total of nine measurements or data points.

In some embodiments of this disclosure, the solar tracker rows 274 that make up a solar array may be single-axis solar trackers. For example, a single-axis solar tracker may have an actuator (e.g., a motor) that operates to move a torque tube about an axis of rotation, thereby changing the angle of orientation of the solar modules operably coupled to the torque tube and disposed along the affected solar tracker row 274.

FIG. 7B is an exemplary listing of parameters 278 that may be used as part of an algorithm for controlling the angle of orientation of the solar tracker rows 274 in order to increase and/or maximize energy production. For example, the parameters 278 may be topographical parameters that may comprise a list of defined inputs that are part of an algorithm that calculates, determines, or estimates the angle of orientation for each individual solar tracker row to increase, maximize, or optimize the overall energy production of the solar array, taking into account a number of inputs such as the position of the sun in the sky, the presence or absence of diffuse light conditions, an observed amount of row-to-row shading on a particular solar tracker row, an observed amount of light on the ground between adjacent solar tracker rows, etc.

The various exemplary parameters 278 shown in FIG. 7B may be calculated or determined based on the three-dimensional location values 276A, 276B, and 276C for the solar tracker rows 274 of a solar array. Thus, any errors made when initially measuring the location values 276A, 276B, and 276C could affect the subsequent performance of a tracking algorithm employed to improve overall performance of the solar array. In some embodiments of this disclosure, methods for observing, detecting, and/or measuring shading on solar tracker rows 274 and light on the ground between solar tracker rows 274 are disclosed. Such measurements may, for example, be used to determine if errors exist in the three-dimensional location values 276A, 276B, and 276C, and to make corrections to the three-dimensional location values 276A, 276B, and 276C as appropriate. Making such corrections to the three-dimensional location values 276A, 276B, and 276C may enable updates to be made to the parameters 278, which may thereby improve the performance of solar tracking algorithms that use the parameters 278. Additionally or alternatively, such measurements may be used to directly and/or automatically make updates to the parameters 278, according to some embodiments.

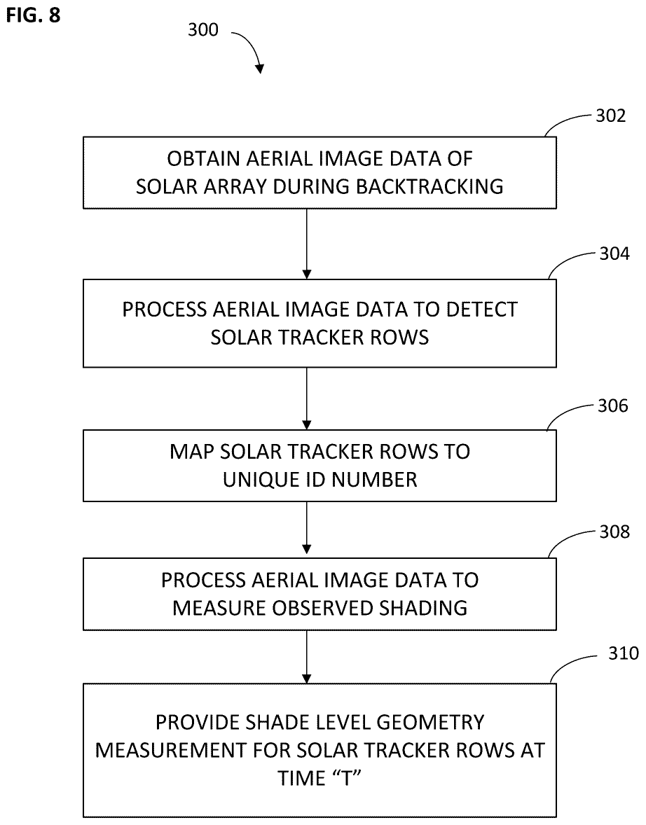

FIG. 8 is a flow chart showing exemplary steps of a method 300 of operating a solar power plant system according to some embodiments of this disclosure. In some embodiments, a method of operating a solar power plant system may include obtaining aerial image data of a solar array during a backtracking period, as shown at step 302 of FIG. 8. Aerial image data of the solar array may include multiple images, according to some embodiments. In some such cases, the multiple images may be used to form a composite aerial image, or composite aerial image data. Obtaining aerial images and aerial image data for a solar array may be performed through the use of aircraft, including for example, unmanned aircraft such as drones. A drone (or drones) may be flown in an automated manner, following a designated route to capture images and/or collect data that can detect the individual solar tracker rows of a solar array and to capture information regarding areas of shading on a particular solar tracker row (e.g., from an adjacent solar tracker row) and/or areas of uncaptured light on the ground between two adjacent solar tracker rows. An unmanned drone aircraft may be well-suited to obtaining such aerial image data, and certain aspects of flying a drone and capturing the aerial image data thereby may be automated and/or simplified via the use of drones. An aerial vehicle, such as an unmanned drone aircraft, may be controlled or programmed to fly in a defined path over the solar array, according to some embodiments. Alternatively, other means may be employed to obtain the aerial image data, such as satellite imagery, for example, where the aerial image data of the solar array is obtained from one or more satellites. Additionally or alternatively, smart modules may be employed to measure shading, according to some embodiments.

As discussed herein, the solar array may include a plurality of solar tracker rows, with the rows arranged in a generally longitudinal orientation. The solar tracker rows may be arranged such that they are spaced apart from each other. For example, a given solar tracker row may be spaced apart from at least one adjacent solar tracker row in a direction generally transverse to the longitudinal orientation of the solar tracker row. Each of the solar tracker rows includes a plurality of solar modules, and each of the solar tracker rows is configured to rotate or tilt the solar modules to a solar tracker angle in response to changes in the position of the Sun as it moves across the sky during the course of a typical day, for example, to maintain a perpendicular relationship to the sun's incident rays to improve energy production. In some embodiments, the backtracking period refers to a period of time in which the solar tracker angle of at least one of the solar tracker rows has been adjusted from a normal or perpendicular angle of incidence relative to the sun, to a backtracking angle that is intended to reduce row-to-row shading (e.g., shade that appears on one solar tracker row caused by the presence of an adjacent solar tracker row).

At step 304 in FIG. 8, the aerial image data obtained in step 302 is processed to detect each of the plurality of solar tracker rows. This may be performed by image analysis software, for example, configured to recognize the contours of the plurality of the individual solar tracker rows. At step 306 in FIG. 8, each of the solar tracker rows detected in the aerial image data is “mapped” to a unique identification number (or unique ID). Mapping a unique ID to each of the individual solar tracker rows may be useful for automating certain tasks and/or for record-keeping of various types of information. For example, the unique ID of a given solar tracker row may be used for communicating with controllers and/or software. A unique ID may be a serial number or some other defined set of alphanumeric characters that may enable a control system to uniquely identify and control each of the solar tracker rows 274 in a solar array. In some cases, it may be more convenient to refer to the solar tracker rows by row numbering scheme (e.g., “row 3”), while in other cases, it may be more convenient to use unique IDs (e.g., ser. No. B327983CW7), and in still other cases, it may be desirable to use both numbering schemes

At step 308 in FIG. 8, the aerial image data is processed to measure (or otherwise quantify) the amount of shading that presents itself on a given solar tracker row. This step 308 may include, for example, receiving or measuring the amount of shading on a first solar tracker row due to (or caused by) a second solar tracker row. Such measuring or quantifying of shading may be performed at a specific time T during a backtracking period, or the shading may be obtained/determined/measured and stored as a function of time during backtracking periods.

At step 310 in FIG. 8, a shade level geometry is measured (or determined) and provided for solar tracker rows at a given time T, or as a function of time. In some cases, the shade level geometry measurement for a given solar tracker row comprises an amount of shading associated with the unique ID of the particular solar tracker row, for example a measured size of the shading. The amount or size of the shading provided may be a value that reflects an amount of shading for an entire solar tracker row. The amount of shading may be expressed as a percentage, such as the percentage of the overall surface area of the solar tracker row that is shaded (or of the solar modules that are shaded). Alternatively, the amount of shading may be expressed as an absolute value, such as the surface area of the shade on the solar modules of a particular solar tracker row. Other numerical scales or numerical scores could be devised to assess or measure the degree to which a solar tracker row is shaded. For example, a scale of 1 to 4, or 0 to 10, etc. could be used to provide the shade level geometry measurement.

The shade level geometry measurement provided by step 310 may be determined for a particular time “T,” or it may be obtained and saved as a function of time. In some embodiments, the shade level geometry measurement may include additional details of the shaded area, for example, details regarding the shape of the shaded area (e.g., triangular at northwest corner of solar tracker row, etc.). In some embodiments, the shade level geometry measurement may be provided with reference to both the shaded solar tracker row and to the adjacent “shading” solar tracker row (e.g., the row causing the shade on the shaded solar tracker row). For example, it may be helpful for the measurement to indicate that the shade on “row 6” at time T is caused by “row 7,” and not by “row 5.” In some further embodiments, the shade level geometry measurement may provide an indication that one or more of the backtracking settings used during the backtracking period needs adjustment. In some such embodiments, if the shade level geometry measurement is below a predetermined threshold, no adjustments are made to any backtracking settings associated with solar tracking algorithms.

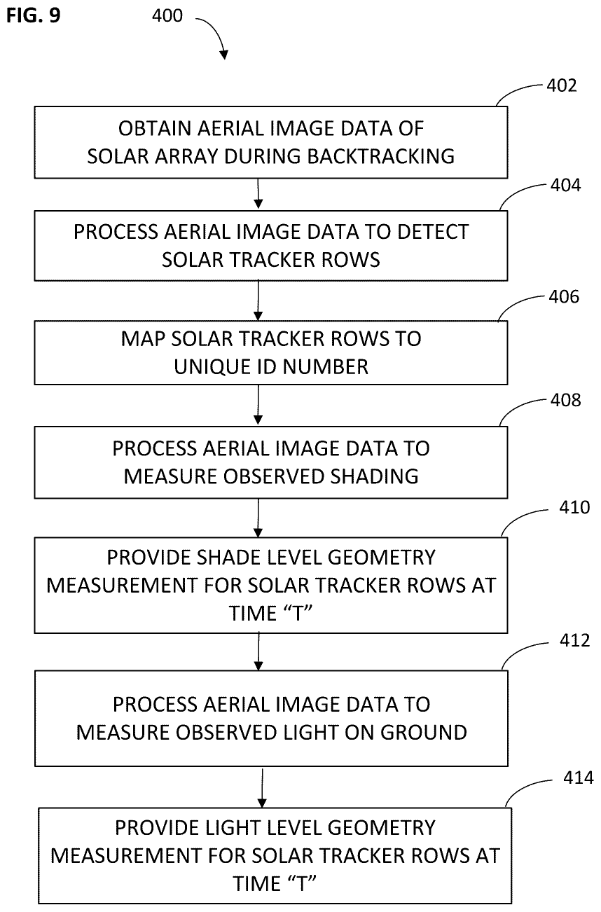

FIG. 9 is a flow chart showing exemplary steps of a method 400 of operating a solar power plant system according to some embodiments of this disclosure. The method 400 illustrated in FIG. 9 is similar to the method 300 shown in FIG. 8, but it adds steps relating to areas of light that appear between adjacent solar tracker rows. Steps 402 through 410 in FIG. 9 are the same as steps 302 through 310 of FIG. 8 with respect to observed shading on solar tracker rows and will not be repeated for the sake of clarity. The additional steps 412 and 414 are discussed in detail below.

At step 412 in FIG. 9, the aerial image data is processed to measure (or otherwise quantify) the amount of light that presents itself on the ground between a given pair of adjacent solar tracker rows (e.g., between a first solar tracker row and a second solar tracker row). Such measuring or quantifying of the uncaptured light on the ground between solar tracker rows may be performed at a specific time T during a backtracking period, or alternatively, the light on ground may be obtained/determined/measured and stored as a function of time during backtracking periods.

At step 414 in FIG. 9, a light level geometry is measured (or determined) and provided for a solar tracker row (or for a pair of solar tracker rows) at a given time T, or as a function of time. In some cases, the light level geometry measurement for a pair of solar tracker rows comprises an amount of light on the ground between two adjacent solar tracker rows; the light level geometry measurement may be associated with, or linked to, the unique IDs of the particular pair of solar tracker rows in question. The amount of light on the ground may be expressed as a percentage, such as the percentage of the lighted area on the ground relative to the total ground area between the adjacent solar tracker rows. Alternatively, the amount of light on the ground may be expressed as an absolute value, such as the surface area of the light on the ground between solar tracker rows. Other numerical scales or schemes could be devised to assess or measure the degree to which light reaches the ground between adjacent solar tracker rows. For example, a scale of 1 to 4, or 0 to 10, etc. could be used to provide the light level geometry measurement. The light level geometry measurement may include both a size and shape of light on the ground, and the measurement may be associated with a unique ID of a particular solar tracker row (or with the unique IDs of a pair of adjacent solar tracker rows). The light level geometry measurement may be determined for a particular time “T,” or it may be obtained and saved as a function of time. In some embodiments, the light level geometry measurement may include additional details of the lighted area on the ground, for example, details regarding the shape of the lighted area (e.g., triangular with apex at south end, etc.).

In some embodiments, aerial image data obtained for the solar array may comprise multiple images; a composite aerial image and/or composite aerial image data may be formed from the multiple images.

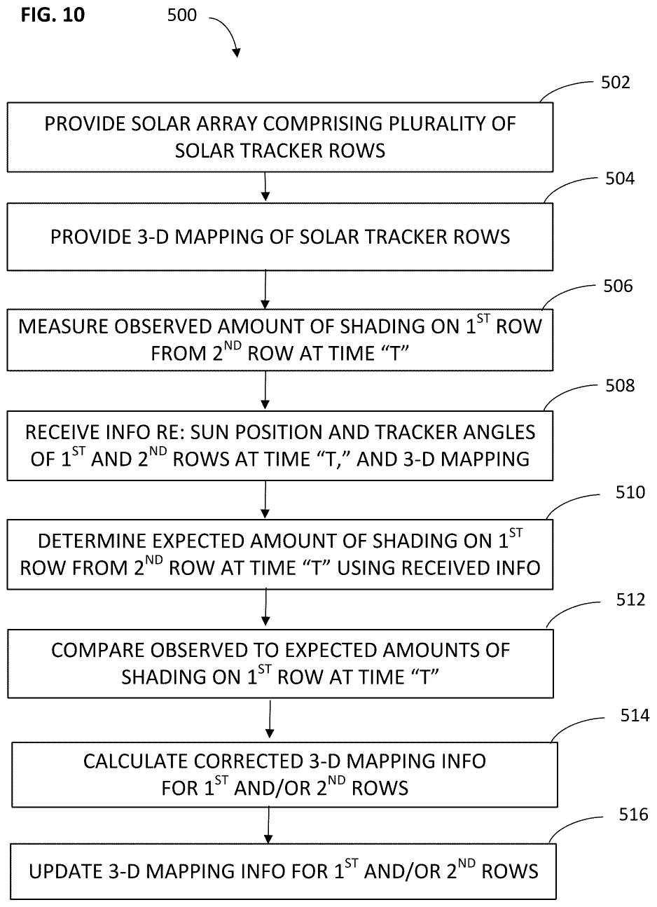

FIG. 10 is a flow chart showing exemplary steps of a method 500 of operating a solar power plant system according to some embodiments of this disclosure. The method 500 illustrated in FIG. 10 may include a step 502 of providing a solar array of the solar power plant system, the solar array comprising a plurality of solar tracker rows. The solar tracker rows may be arranged in a generally longitudinal orientation (e.g., typically oriented in a north-south longitudinal orientation). The plurality of solar tracker rows of the solar array may be spaced apart from each other in a direction that is generally transverse to the longitudinal orientation. Each solar tracker row has a plurality of solar modules coupled thereto, and the solar tracker rows are configured to tilt or rotate to an angle (e.g., a controllable solar tracker angle), for example, in response to the changing position of the Sun as it traverses the sky throughout the day.

At step 504 in FIG. 10, the method 500 includes providing an initial three-dimensional mapping (e.g., a topographical mapping) of the solar tracker rows disposed and/or arranged across the solar array. The initial three-dimensional mapping of the solar tracker rows provided in step 504 may be similar or analogous to the table of position information shown in FIG. 7A and described above with reference to FIG. 7A. For example, the initial three-dimensional mapping may include a plurality of X, Y, and Z coordinates that define a plurality of locations corresponding to portions of solar tracker rows disposed in the solar array. The Z coordinates, for example, may define a corresponding height or elevation of the solar tracker rows at each of the plurality of locations. In some embodiments, the reference to an “initial” three-dimensional mapping of the solar tracker rows may refer to the mapping (e.g., the measuring and recording) of positions (e.g., position information such as latitude, longitude, elevation/height) performed during the initial installation of the solar tracker rows of the solar array. Alternatively, or additionally, the “initial” three-dimensional mapping of the solar tracker rows may refer to the current or most recent set of mapping information, which may be periodically updated and corrected or refined over time (e.g., to correct for errors, to account for changes in terrain and/or settling of the ground, etc.).

At step 506 in FIG. 10, the method 500 may include receiving or measuring an observed amount of shading on one solar tracker row caused by a different solar tracker row. In some embodiments, this may include receiving or measuring an amount of shading observed on a first solar tracker row due to a second solar tracker row at a time T, where the second solar tracker row is adjacent (e.g., next to, or immediately adjacent in some cases) to the first solar tracker row. The measurement of observed shading may be performed as described above, for example, via the use of aerial imagery, including unmanned drone aircraft or satellites as possible examples. Additionally or alternatively, smart modules may be employed to measure shading, according to some embodiments.

At step 508 in FIG. 10, the method 500 may include receiving information that may have an effect on the amount of shading that results on a given solar tracker row. For example, the information received may include information regarding: the position of the Sun at the time T; the solar tracker angles of the first and second solar tracker rows at the time T, and the initial three-dimensional mapping information for the first and second solar tracker rows. Other information may also be received or retrieved during this step, for example, information regarding the dimension (e.g., length, width, thickness, etc.) of the various solar tracker rows, or the spacing between solar tracker rows, for example.

At step 510 in FIG. 10, the method 500 may include determining (e.g., calculating or estimating) an expected amount of shading on the first solar tracker row due to the second solar tracker row at the time T. For example, using the three-dimensional mapping information received in step 508, along with information received regarding the Sun position and the solar tracker angles, it may be possible to calculate the expected amount of shading to occur on the first solar tracker row due to the second solar tracker row at a particular time T. It should be noted that additional information may also be provided in step 510 to enable the calculation of expected shading. For example, it may be helpful in some embodiments to also provide information regarding the dimensions (e.g., length, width, thickness) of the solar modules and/or of their supporting structures on the respective solar tracker rows, as well as the spacing between the solar tracker rows, etc.

At step 512 in FIG. 10, the method 500 may include comparing the observed amount of shading to the expected amount of shading. This step may, for example, include quantifying the difference between the observed and expected amounts of shading. If such a comparison shows a significant difference between the expected amount of shading and the observed amount of shading (e.g., a difference greater than some threshold amount), this may be an indication that the initial three-dimensional mapping of solar tracker rows is not completely accurate and may possibly benefit from making a correction or an update thereto. On the other hand, if the comparison shows no difference (or shows a difference that is less than a threshold amount), this may be useful as confirmation of the accuracy of the initial (or currently existing) three-dimensional mapping of solar tracker rows, and no further action need be taken in such a situation.

At step 514 in FIG. 10, for cases where the comparison made in step 512 shows a difference between observed and expected amounts of shading, the method 500 may calculate corrected Z coordinate values (e.g., elevation or height values) along either the first solar tracker row or the second solar tracker row that would yield or produce the observed amount of shading.

At step 516 in FIG. 10, the method 500 may include updating the three-dimensional mapping information for the first solar tracker row and/or the second solar tracker row with the updated/corrected Z coordinate values calculated in step 514, and continuing operation of the solar power plant (e.g., continuing to operate the solar array to track the position of the Sun and to generate power). Updating the positional information or mapping information of the solar tracker rows in three-dimensional space in this manner may yield benefits (e.g., increases) in overall plant efficiency by improving the effectiveness of various solar tracking algorithms such as backtracking, according to embodiments of this disclosure.

In some further embodiments, the method 500 may include various additional steps. For example, similar to the steps outlined above with respect to shading on solar tracker rows, analogous steps may be performed with respect to uncaptured light that reaches the ground between a pair of adjacent solar tracker rows. In some cases, such steps to analyze the effects of uncaptured light may occur if the observed amount of shading on one solar tracker row due to an adjacent solar tracker row at time T is zero. In such case, the method may comprise receiving or measuring an observed amount of uncaptured light between a first solar tracker row and a second solar tracker row at a given time T. This may include, for example, measuring a width of a light beam (or receiving a measured width of a light beam) that reaches a ground surface between adjacent solar tracker rows at time T.

The method may further comprise determining (e.g., calculating or estimating) an amount of uncaptured light (e.g., an amount of light that is expected to reach the ground) between the first solar tracker row and the second solar tracker row at the time T. This step may be performed using information received and/or retrieved during an earlier step, for example. The method may then compare the observed amount of uncaptured light to the expected amount of uncaptured light, and use the results of the comparison to calculate corrected z coordinate values; the corrected z coordinate values may be determined, for example, such that, if applied to one or more points along either (or both) of the first solar tracker row or the second solar tracker row, they would result in or produce the observed amount of uncaptured light.

The method may further comprise updating the three-dimensional mapping of the first solar tracker row or the second solar tracker row with the corrected z coordinate values, and using the updated three-dimensional mapping of solar tracker rows during continued operation of the solar power plant system, including during the use of various solar tracking algorithms such as backtracking, for example.

Various non-limiting exemplary embodiments have been described. It will be appreciated that suitable alternatives are possible without departing from the scope of the examples described herein. For example, the methods described herein describe a technique for correcting the elevation or height values (the “Z-coordinate” values) of positions along the length of a given solar tracker row. However, it should be noted that this is exemplary only and has been for clarity and/or simplicity. It is noted, for example, that errors in the X and/or Y coordinates (e.g., longitude and/or latitude) could similarly affect the amount of shading and/or light-on-ground conditions that may result. Thus, the techniques described herein could be readily applicable to situations involving errors in any or all three dimensions.

What is claimed is:

1. A method of operating a solar power plant system, the method comprising:
providing an initial three-dimensional mapping of a plurality of solar tracker rows across a solar array, the three-dimensional mapping comprising a plurality of X, Y, and Z coordinates, wherein the X and Y coordinates define a plurality of locations in the solar array, wherein the Z coordinates define a corresponding height of the solar tracker row at each of the plurality of locations, and wherein each of the solar tracker rows comprises a plurality of solar modules, each of the solar tracker rows configured to rotate the plurality of solar modules relative to a position of the Sun;
receiving an observed amount of shading on a first solar tracker row due to a second solar tracker row at a time T, the second solar tracker row being adjacent the first solar tracker row;
receiving information regarding: the position of the Sun at the time T, a solar tracker angle of the first solar tracker row at the time T, a solar tracker angle of the second solar tracker row at the time T, and the initial three-dimensional mapping of the first solar tracker row and the second solar tracker row;
determining an expected amount of shading on the first solar tracker row due to the second solar tracker row at the time T;
comparing the observed amount of shading to the expected amount of shading;
calculating corrected X, Y, and/or Z coordinate values along either the first solar tracker row or the second solar tracker row that would produce the observed amount of shading;
updating the three-dimensional mapping of the first solar tracker row or the second solar tracker row with the corrected X, Y, and/or Z coordinate values; and
changing the solar tracker angle of the first solar tracker row or the second solar tracker row to reduce the observed amount of shading on the first solar tracker row due to the second solar tracker row at a time T2 later than the time T using the updated three-dimensional mappings.

2. The method of claim 1, wherein if the observed amount of shading on the first solar tracker row due to the second solar tracker row at the time T is zero, the method further comprises:
receiving an observed amount of uncaptured light between the first solar tracker row and the second solar tracker row at the time T;
determining an expected amount of uncaptured light between the first solar tracker row and the second solar tracker row at the time T;
comparing the observed amount of uncaptured light to the expected amount of uncaptured light;
calculating corrected X, Y, and/or Z coordinate values along either the first solar tracker row or the second solar tracker row that would produce the observed amount of uncaptured light; and
updating the three-dimensional mapping of the first solar tracker row or the second solar tracker row with the corrected X, Y, and/or Z coordinate values.

3. The method of claim 2, wherein receiving the observed amount of uncaptured light between the first solar tracker row and the second solar tracker row at the time T comprises receiving a width of a light beam on a ground surface at the time T.

4. The method of claim 2, further comprising changing the solar tracker angle of the first solar tracker row or the second solar tracker row to reduce the observed amount of uncaptured light between the first solar tracker row and the second solar tracker row at a time T3 later than the time T using the updated three-dimensional mappings.

5. The method of claim 1, wherein the observed amount of shading received is a function of a position along a length of the first solar tracker row.

6. The method of claim 1, wherein the observed amount of shading received is a percentage of a surface area of a plurality of solar modules disposed along a length of the first solar tracker row.

7. The method of claim 2, wherein receiving the observed amount of shading on the first solar tracker row due to the second solar tracker row at the time T, or receiving the observed amount of uncaptured light between the first solar tracker row and the second solar tracker row at the time T, comprises obtaining aerial imagery of the solar array.

8. The method of claim 7, wherein the aerial imagery of the solar array is obtained using unmanned aircraft.

9. A method of operating a solar array, the solar array comprising a plurality of solar tracker rows arranged in a generally longitudinal orientation, each of the plurality of solar tracker rows spaced apart from at least one adjacent solar tracker row in a direction generally transverse to the longitudinal orientation, each of the solar tracker rows comprising a plurality of solar modules, each of the solar tracker rows configured to rotate to a solar tracker angle in response to a position of the Sun, the method comprising:
providing an initial three-dimensional mapping of the solar tracker rows across the solar array, the three-dimensional mapping comprising a plurality of X, Y, and Z coordinates, wherein the X and Y coordinates define a plurality of locations in the solar array, and wherein the Z coordinates define a corresponding height of the solar tracker row at each of the plurality of locations;
receiving an observed amount of shading on a first solar tracker row due to a second solar tracker row at a time T, the second solar tracker row being adjacent the first solar tracker row;
receiving an observed amount of uncaptured light between the first solar tracker row and the second solar tracker row at the time T;
receiving information regarding: the position of the Sun at the time T, a solar tracker angle of the first solar tracker row at the time T, a solar tracker angle of the second solar tracker row at the time T, and the initial three-dimensional mapping of the first solar tracker row and the second solar tracker row;
determining an expected amount of shading on the first solar tracker row due to the second solar tracker row at the time T;
determining an expected amount of uncaptured light between the first solar tracker row and the second solar tracker row at the time T;
comparing the observed amount of shading to the expected amount of shading and comparing the observed amount of uncaptured light to the expected amount of uncaptured light;
calculating corrected X, Y, and/or Z coordinate values along either the first solar tracker row or the second solar tracker row that would produce the observed amount of shading or the observed amount of uncaptured light;
updating the three-dimensional mapping of the first solar tracker row or the second solar tracker row with the corrected X, Y, and/or Z coordinate values; and
changing the solar tracker angle of the first solar tracker row or the second solar tracker row to either (a) reduce the observed amount of shading on the first solar tracker row due to the second solar tracker row at a time T2 later than the time T using the updated three-dimensional mappings, or (b) reduce the observed amount of uncaptured light between the first solar tracker row and the second solar tracker row at a time T3 later than the time T using the updated three-dimensional mappings.

10. A method of operating a solar power plant system, the method comprising:
obtaining aerial image data of a solar array during a backtracking period, the solar array comprising a plurality of solar tracker rows and the backtracking period comprising a period of time in which a solar tracker angle of at least one of the plurality of solar tracker rows has been adjusted from a perpendicular angle of incidence to the Sun to a backtracking angle that reduces shading of an adjacent solar tracker row by the at least one solar tracker row;
processing the aerial image data to detect each solar tracker row of the plurality of solar tracker rows of the solar array;
mapping each solar tracker row to a unique identification number (“unique ID”);
processing the aerial image data to measure an observed amount of shading on a first solar tracker row due to a second adjacent solar tracker row at a time T during the backtracking period;
providing a shade level geometry measurement for each solar tracker row at the time T, the shade level geometry measurement comprising an amount of shading associated with a given solar tracker row's unique ID;
determining that one or more backtracking settings used during the backtracking period need adjustment based on the shade level geometry measurement; and
adjusting the one or more backtracking settings based on the shade level geometry measurement.

11. The method of claim 10, wherein obtaining aerial image data of the solar array comprises flying an aerial vehicle in a defined path over the solar array.

12. The method of claim 10, wherein aerial image data of the solar array is obtained from one or more satellites.

13. The method of claim 1, wherein aerial image data of the solar array comprises a composite aerial image formed from multiple images.

14. The method of claim 10, wherein the amount of shading provided by the shade level geometry measurement is a size.

15. The method of claim 14, wherein the size of the amount of shading is expressed as one of a surface area shaded, a percentage of solar module shading, or a numerical score.

16. The method of claim 14, wherein the amount of shading provided by the shade level geometry measurement further comprises a shape.

17. The method of claim 10, wherein the shade level geometry measurement is provided with reference to both a shaded solar tracker row and an adjacent shading solar tracker row.

18. The method of claim 10, further comprising:
processing the aerial image data to measure an observed amount of light on a ground surface between the first solar tracker row and the second solar tracker row at a time T during the backtracking period; and
providing a light level geometry measurement for each solar tracker row identification number at the time T, the light level geometry measurement comprising a size and shape of light associated with a given solar tracker ID number.

19. The method of claim 18, wherein the light level geometry measurement is provided with reference to two adjacent solar tracker rows.
